(19) United States
(12) Patent Application Publication
(10) Pub. No.: US 2010/0234007 A1
(43) Pub. Date: Sep. 16, 2010

(54) MULTIMEDIA CELL PHONE AND METHOD FOR CHANGING VIDEO BACKGROUND THEREOF

(76) Inventor: Dan SHAO, Xi'an (CN)

Correspondence Address: Muncy, Geissler, Olds & Lowe, PLLC, 4000 Legato Road, Suite 310, FAIRFAX, VA, 22033, US

(21) Appl. No.: 12/718,320

(22) Filed: Mar. 5, 2010

(30) Foreign Application Priority Data
Mar. 11, 2009 (TW) 098107862

(51) Int. Cl. H04M 3/00

(52) U.S. Cl. 455/418

(57) ABSTRACT

A method for changing a video background of a multimedia cell phone includes the following steps. A video image provided with a preset background color is chosen. An original image is recorded. A video communication is activated. A replacement region of the original image is determined, wherein a color of the replacement region is substantially the same as the preset background color. The replacement region of the original image is replaced with a corresponding region of the video image to form a new image. The new image is transmitted by a communication module.

### BACKGROUND THEREOF

This application claims the benefit of the Taiwan Patent Application Serial NO. 098107862, filed on Mar. 11, 2009, the subject matter of which is incorporated herein by reference.

### BACKGROUND OF THE INVENTION

1. Field of the Invention

The present invention relates to a method for changing a video background, more particularly to a multimedia cell phone and a method for changing the video background thereof.

2. Description of the Prior Art

In our daily life, in order hide the location per se when talking over the phone, the user may mix a preset background music together with the talking voice, thereby creating an environment leading the other party unable to guess the exact location of the opposite communicator.

Due to the rapid prevalence of multimedia cell phones, there is a change of communication system among the communicators. In other words, more and more people are using video communication, i.e., one user can see the opposite party on the display screen due to presence of video cams on the cell phones while the two are talking over the cell phones.

The reasons reside in that voice signals as well as the video images are transmitted continuously and simultaneously between the two multimedia cell phones. Under such condition, in case he or she intends to hide his or her location per se, mere changing or mixing the environmental music can only convince wrong guessing of whereabouts but fails to hide the actual background of the location per se.

### SUMMARY OF THE INVENTION

As stated above, when using the multimedia cell phones for conducting the video communication, the video cams transmit the images simultaneously during the conversation over the cell phones. Under such condition, mere changing or mixing the environmental music can only convince wrong guessing of whereabouts but fails to hide the actual background of the location per se.

Therefore, the object of the present invention is to provide a multimedia cell phone and a method for changing the video background thereof. Therefore, the user of the multimedia cell phone can change the video background of the location from where he is talking when using his multimedia cell phone to conduct the video communication with the other party.

A method is provided according to the present invention for changing the video background of a multimedia cell phone. The method for changing the video background of a multimedia cell phone includes the steps of: (a) choosing a video image having a preset background color; (b) recording an original image; (c) activating a video communication; (d) determining a replacement region in the original image, wherein the color of the replacement region is the same as the preset background color; (e) replacing the replacement region in the original image with a corresponding region of the video image to form a new image; and (f) transmitting the new image by a communication module.

A multimedia cell phone of the present invention includes an image fetching unit, a processing unit and a communication module. The image fetching unit is used for obtaining a video image having a preset background color. The processing unit is used for determining a replacement region of an original image, wherein the color of the replacement region is substantially the same as the preset background color. The processing unit is further used for replacing the replacement region of the original image with a corresponding region of the video image to form a new image. The communication module is used for transmitting the new image.

In the prior method for changing the background from where one person is using his multimedia cell phone, only the background environmental noise is mixed with a certain music. In contrast, in the present method for changing the video background of the location, from where the user is talking over the multimedia cell phone, some regions in the original image are replaced by the corresponding regions in the video image, thereby converting the original image into a new image. Thus, when the present method is implemented in the multimedia cell phone, the user is capable of concealing his video background of the location per se, from where the user is talking over his multimedia cell phone.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a block diagram illustrating the steps in a method according to the present invention for changing the video background of a multimedia cell phone;

FIG. 2 illustrates how a video image and an original image are employed in order to form a new image for serving as the video background in the present method for changing the video background of the multimedia cell phone; and

FIG. 3 is a block diagram representing the multimedia cell phone of the present invention.

### DETAILED DESCRIPTION OF THE PREFERRED EMBODIMENT

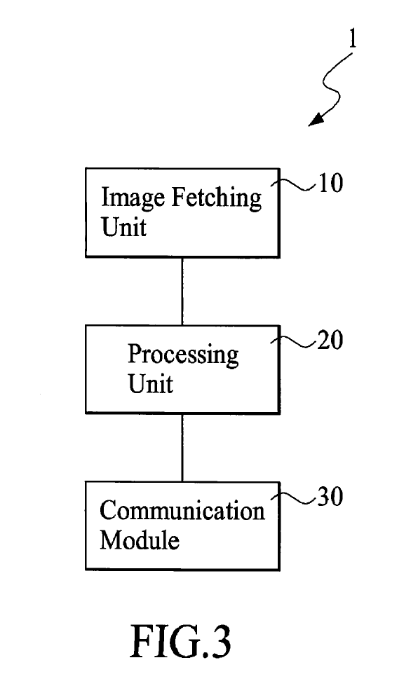

A method is provided according to the present invention and is installed in a multimedia cell phone for changing the video background of the multimedia cell phone. FIG. 3 is a block diagram representing the multimedia cell phone of the present invention. The multimedia cell phone 1 of the present invention includes an image fetching unit 10, a processing unit 20 and a communication module 30. The image fetching unit 10 is used for obtaining a video image having a preset background color. The processing unit 20 is used for determining a replacement region of an original image, wherein the color of the replacement region is substantially the same as the preset background color. The processing unit 20 is further used for replacing the replacement region of the original image with a corresponding region of the video image to form a new image. The communication module 30 is used for transmitting the new image.

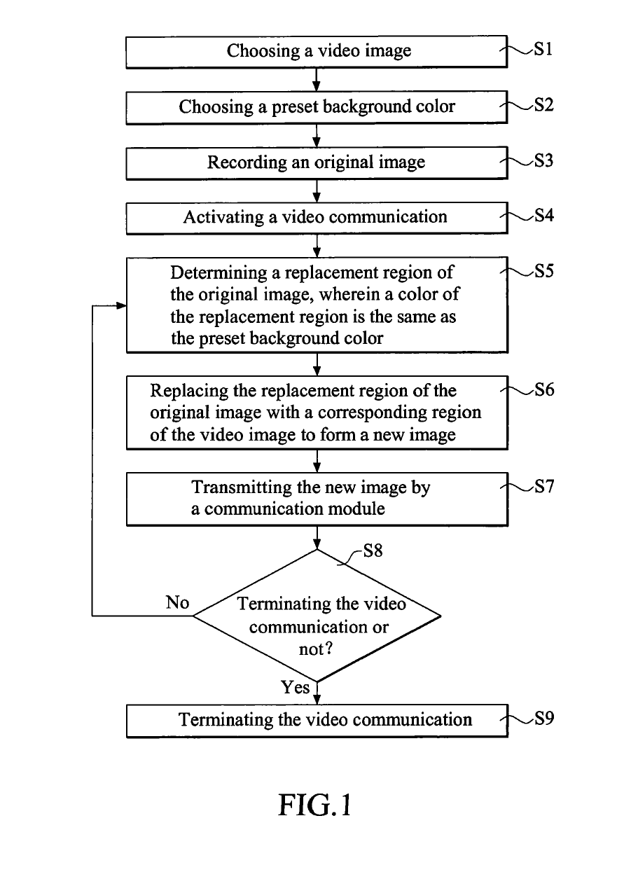

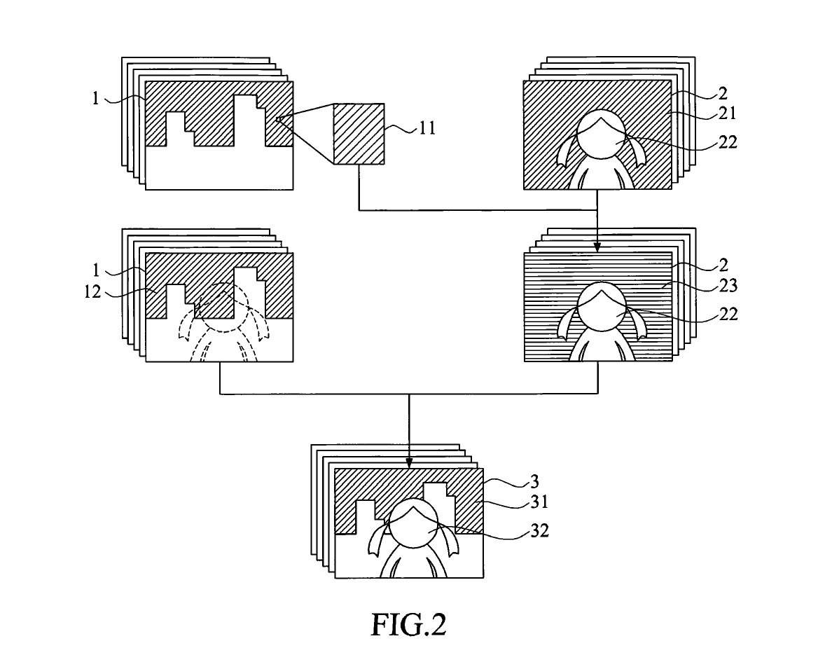

Please refer to FIG. 1 and FIG. 2 at the same time. FIG. 1 is a block diagram illustrating the steps in a method according to the present invention for changing the video background of the multimedia cell phone 1 of the present invention. FIG. 2 illustrates how a video image and an original image are employed in order to form a new image for serving as the video background in the present method for changing the video background of the multimedia cell phone 1.

As illustrated, the method accordingly includes (S1) choosing a video image (such as a desired video image); (S2) selecting a preset background color for the video image; (S3) recording an original image; (S4) activating a video communication in the multimedia cell phone 1 of the present invention; (S5) using the image processing unit 20 to determine a replacement region in the original image, wherein the color of the replacement region is the same as the preset background color; (S6) using the image processing unit 20 to replace the replacement region in the original image with a corresponding region of the video image to form a new image; (S7) transmitting the new image by the communication module 30 of the multimedia cell phone 1 of the present invention; (S8) terminating the video communication or not; and (S9) terminating or finishing the video communication.

In the step (S1) of this embodiment, the video image 1 is, for example, a still image of a video comprising several still images, as illustrated in FIG. 2. The video image can be a MOV file, an AVI file or a MPEG4 file. In other embodiments, the video image can be a photograph which is a JPG file, a TIFF file or a PNG file. Beside, the video image can be obtained by fetching with the image fetching unit 20 or by downloading from the Internet.

In the step (S2), the preset background color 11 is selected by the user, as shown in FIG. 2. The preset background color 11 is preferably chosen from a color chart or any pixel in the video image 1. In other embodiments, the background color 11 can be obtained by calculating the pixel value of a portion of the video image 1 with a processing unit.

In the step (S3) and as illustrated in FIG. 2, the image fetching unit 10 (or image fetching unit) installed on the multimedia cell phone is applied to record the original image 2 for future use. The original image 2 includes a shooting background 21 having the same or similar color as the preset background color 11 in the video image 1 and a shooting object 22.

In the step (S4), the user can switch on his multimedia cell phone in order to conduct the video communication. In the step (S5) and as illustrated in FIG. 2, the image processing unit installed within the multimedia cell phone is applied to determine the original image 2 relative to the preset background color 11, thereby finding out a replacement region 23 in the original image 2, wherein the color of the replacement region 23 is substantially the same as the preset background color 11.

In the step (S6) and as illustrated in FIG. 2, the image processing unit 20 installed within the multimedia cell phone 1 is applied to replace the replacement region 23 in the original image with a corresponding region 12 of the video image 11 to form a new image 3. In other words, the new image 3 includes two parts, namely: the new background 31 and the new shooting object 32. Note that, the new background 31 has the color substantially the same as the corresponding region 12 while the new shooting object 32 has the color substantially the same as the shooting object 22.

In the step (S7), the communication module 30 within the multimedia cell phone 1 is used for transmitting the new image 3 to the other end. Preferably the communication module 30 is operated under a 3G (3rd. Generation) system.

In the step (S8), after transmitting the new image 3 via the communication module 30 in the multimedia cell phone 1 to the other end, the user is to determine whether the video communication is to be terminated or not. If yes, then the step (S9) is executed. If not, the step (S5) is repeated constantly until the video communication is determined to be terminated. In the step (S9), the video communication is terminated

As stated above, in the multimedia cell phone 1 and the method for changing the video background thereof, from where the user is talking over the multimedia cell phone, some regions in the original image are replaced by the corresponding regions in the video image, thereby forming a new image. Thus, when the present method is implemented in the multimedia cell phone, the user is capable of concealing his video background of the location, from where the user is talking over his multimedia cell phone.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for changing a video background of a multimedia cell phone, comprising the steps of:
(a) choosing a video image having a preset background color;
(b) recording an original image;
(c) activating a video communication;
(d) determining a replacement region of the original image, wherein a color of the replacement region is substantially the same as the preset background color;
(e) replacing the replacement region of the original image with a corresponding region of the video image to form a new image; and
(f) transmitting the new image by a communication module.

2. The method according to claim 1, further comprising the step of: (g) repeating the step (d) until the video communication is finished.

3. The method according to claim 1, wherein the video image is obtained by an image fetching unit of the multimedia cell phone.

4. The method according to claim 1, wherein the multimedia cell phone is operated under a 3G (3rd. Generation) system.

5. The method according to claim 1, wherein the video image is a photograph.

6. The method according to claim 5, wherein the video image is a JPEG file.

7. The method according to claim 1, wherein the video image is a still image.

8. The method according to claim 7, wherein the video image is an AVI file.

9. The method according to claim 1, wherein the preset background color is selected from the video image.

10. The method according to claim 1, where in the preset background color is selected from a color chart.

11. A multimedia cell phone comprising:
an image fetching unit for obtaining a video image having a preset background color;
a processing unit for determining a replacement region of an original image, wherein a color of the replacement region is substantially the same as the preset background color, and the processing unit further replacing the replacement region of the original image with a corresponding region of the video image to form a new image; and
a communication module for transmitting the new image.

12. The multimedia cell phone according to claim 11, wherein the multimedia cell phone is operated under a 3G (3rd. Generation) system.

13. The multimedia cell phone according to claim 11, wherein the video image is a photograph.

14. The multimedia cell phone according to claim 13, wherein the video image is a JPEG file.

15. The multimedia cell phone according to claim 11, wherein the video image is a still image.

16. The multimedia cell phone according to claim 15, wherein the video image is an AVI file.

17. The multimedia cell phone according to claim 11, wherein the processing unit is further used for selecting the preset background color from the video image.

18. The multimedia cell phone according to claim 11, wherein the processing unit is further used for selecting the preset background color from a color chart.
